(19) United States
(12) Patent Application Publication
(10) Pub. No.: US 2026/0073745 A1
(43) Pub. Date: Mar. 12, 2026

(54) ELECTRONIC LOCK SYSTEM INCORPORATING LOCK MANAGEMENT

(71) Applicant: Skye Partners LLC, Gilbert, AZ (US)

(72) Inventors: Chris Calvert, GILBERT, AZ (US); Chris Piper, Naples, FL (US); Anton Shvydkyi, Boiarka (UA); Alexander Simone, San Diego, CA (US)

(21) Appl. No.: 19/387,586

(22) Filed: Nov. 12, 2025

Related U.S. Application Data
(63) Continuation of application No. PCT/US24/55214, filed on Nov. 8, 2024.
(60) Provisional application No. 63/597,670, filed on Nov. 9, 2023.

(51) Int. Cl. G07C 9/00

(52) U.S. Cl. CPC G07C 9/00309; G07C 9/00571; G07C 9/00896; G07C 2009/00769; G07C 2209/02; G07C 2209/04; G07C 2209/62

(57) ABSTRACT

An electronic lock system, configured for use primarily on a construction site gate, is configured to monitor and record who has unlocked or lock the electronic lock. The lock system incorporates a mechanical lock configured to be locked to a first gate, and an electronic lock configured to be locked on a second gate. A rigid bar may extend between the mechanical lock and the electronic lock and requires the gate or gates to be closed for locking. The shackles may be unlocked and locked by a key by a supervisor and then the bar may be operated by workers with their electronic device. The electronic lock system records an identifier of the electronic device used to operate the lock. The lock configuration of the gate or gates can be determined by review of the lock status from a database to determine a responsible person to lock an unlocked gate.

### CROSS REFERENCE TO RELATED APPLICATIONS

This application is a continuation in part of international patent application No. PCT/US2024/055214, filed on Nov. 8, 2024, which claims the benefit of priority to U.S. provisional patent application No. 63/597,670, filed on Nov. 9, 2023; the entirety of all prior priority applications are hereby incorporated by reference herein.

### BACKGROUND OF THE INVENTION

### Field of the Invention

The invention relates to an electronic lock system that incorporates a lock management system to monitor the lock position and who was last to activate the lock.

### Background

Construction sites are often secured by a fence that extends around the perimeter of the construction site to prevent the public from entering the hazardous construction site and to prevent valuable materials from being stolen. Typically, a chain is wrapped from one fence gate to another or to a fixed object and locked with a padlock. This flexible chain and padlock is not a very secure locking system, as the chain can be cut rather easily with bolt cutters. Also, this lock arrangement enables the lock to be secured in a locked configuration without actually securing the gate or fence, thereby providing a false sense of security and potentially allowing unauthorized access into the construction site.

### SUMMARY OF THE INVENTION

The invention is directed to an electronic lock system, configured for use primarily on a construction site gate and monitors and records who has unlocked or locked the electronic lock via interfacing with their electronic device, such as a mobile phone. A record of who has unlocked the gate is accessible through the system application software (APP) on mobile phones of registered users and managers of the electronic lock. When a person unlocks the electronic lock, they have responsibility to re-lock the lock or they may transfer responsibility to another person. In this way, there is always someone having the responsibility to re-lock an opened lock, such as at the end of the day and this responsibility may be viewed through the APP.

The lock system incorporates a mechanical lock configured with a shackle to be locked to a first shackle retainer, such as one gate, and an electronic lock, with a shackle configured to be locked on a second shackle retainer, such as a second gate. A rigid bar may be configured to extend between the mechanical lock and the electronic lock and requires the gate or gates to be closed for the bar to rotate from the mechanical lock into the electronic lock for locking thereto. The shackles may be unlocked and locked by a key or keys by a supervisor and then the bar may be locked and unlocked by workers with their electronic device as they enter and exit through the gate. The electronic lock system will record an identifier of the electronic device each time an electronic device, such as a mobile phone, is used to lock or unlock the bar from the electronic lock. In this way, the lock configuration of the gate or gates can be determined by review of the lock status from a database.

A system application software (APP) may be part of the electronic lock system and may be operated on a mobile phone to view the status of the lock, operate the electronic lock to lock and unlock, and to manage who has rights to locking and unlocking the lock. The electronic lock system may incorporate a wireless transceiver that receives a wireless signal from the mobile phone to operate the electronic lock. The electronic lock may only be configured to unlock and lock the bar from the electronic lock body and may not operate to lock or unlock the electronic shackle. The electronic lock may be actuated from a wireless signal from an electronic device or it may require that the lock button on the electronic lock body is manually interfaced with to cause the electronic lock to actuate. Also, the wireless signal transceiver of the electronic lock may utilize a short-range signal and therefore require that a person be in close proximity to the electronic lock body to enable the electronic lock to be actuated. Short-range wireless technologies include Bluetooth, Wi-Fi, NearLink, near-field communication (NFC), LPWAN, ultra-wideband (UWB) and IEEE 802.15.4. They are implemented by chips fabricated as RF CMOS integrated circuit (RF circuit). A short-range distance may be about 100 m or less, about 75 m or less, about 50 m or less, about 30 m or less, about 20 m or less, about 10 m or less and any range between and including the short-range distances provided.

The system application software (APP) and/or the electronic lock may interface with a database that enables data and information regarding the status of the lock to be viewed by others that are not within a close proximity to the worksite or electronic lock. The electronic lock wireless signal transceiver may communicate directly through a cellular signal or through a link to the database, such as through a wi-fi link.

A system manager may have to approve a new user of the system when they subscribe to the system through the APP. A quick response code may be configured on the lock, such as on the front face of the electronic or mechanical lock body to enable a person to download the APP and subscribe. A quick response code is a type of two-dimensional matrix barcode and may also be a bar code. A system manager may confirm or deny access to use the APP for operating the electronic lock. A system manager may open the contacts on their mobile phone and select people to add as authorized users of a particular lock. The APP may enable the manager to set date ranges, days of the week, and time ranges for the authorization of a particular individual to a particular electronic lock. The APP may enable the status of a plurality of electronic locks to be viewed and enable a manager to change and modify authorization of a plurality of locks.

The status of the electronic lock may be viewed in the APP along with details regarding when the lock was actuated (locked or unlocked), time of actuation, and identifier regarding the mobile device used to actuate the lock, such as name or phone number. When a person, such as a construction worker unlocks the lock, they may then be responsible for assuring that the lock is later locked, such as at the end of the day. The responsible person for re-locking the electronic lock may transfer the responsibility and authority for re-locking the lock to another person and this person may have to accept the responsibility before they are then confirmed as the responsible person as then updated on the APP. A site manager may be responsible for locking the lock at the end of the work day and may transfer this responsibility to someone else when they are offsite, for example.

An exemplary electronic lock may be opened by a first worker and the first workers mobile device identifier is recorded by the system. The first worker may then have to leave early and may transfer the responsibility to a second worker by opening the APP and selecting an authorized user for transferring responsibility. The second worker will receive a notice on their mobile device or mobile phone through the APP requesting that they accept responsibility. If they accept the responsibility, then the first worker is notified of this and the system is updated to show that the second worker is the responsible person for re-locking the lock. If the second worker declines responsibility, then the first worker is notified and they may then select a third worker to request their acceptance of responsibility. In this way, there is always a person responsible for relocking the lock.

The mechanical lock has a shackle, a “mechanical shackle” as used herein to differentiate from the shackle on the electronic lock, the “electronic shackle”, wherein both can be locked and unlocked to enable the shackles to be positioned around shackle retainers, such as a fence post, or gate post. In an exemplary embodiment, the mechanical shackle is detachably attachable to the mechanical lock body, wherein the first arm and second arm of the shackle detach from the mechanical lock body. In an exemplary embodiment, the electronic shackle is detachably attachable to the electronic lock body, wherein the first arm and second arm of the electronic shackle detach from the electronic lock body. Note that just one arm may pull out from the body to enable the shackle, mechanical or electronic, to rotate for locking about a shackle retainer. A detachable shackle may be desired for compact shipping, however.

An exemplary shackle, mechanical shackle or electronic shackle, may be a U-shaped component that has a connecting portion between a first arm and a second arm. The first arm and second arms may extend parallel to each other and the connection portion may include a curved portion to couple with these two offset arms. A shackle may be a rigid component, unlike a flexible chin, and is stiff, rigid and made of metal or composite material. A shackle may be a monolithic part made of metal or composite material and may be U-shaped having two arms and a connector extending between the two arms. A shackle has a lock receiver, such as a recess forming a flange, or a flange alone, that is configured to be coupled with a deadbolt or a shackle latch to secure the shackle to the lock body. A lock receiver may be a groove in one or both of the shackle arms and may be configured proximal to the extended ends of the arm or arms.

The shackles, mechanical shackle and/or electronic shackle may be configured to be locked and unlocked to the respective mechanical lock body and electronic lock body by a key, a physical key. Each of the mechanical deadbolt and/or electronic deadbolt may have a key receiver that is coupled with a key mechanism that physically moves a deadbolt to lock and unlock the shackle. In this way, a key may be used for installation and then the electronic lock may be used to only unlock and lock the bar from the electronic lock body. Also, the key may unlock and lock the bar from the mechanical lock by releasing or locking the bar pin to the mechanical lock. The bar may be configured to be locked in a desired position, through one of the plurality of bar pin apertures to configure the lock end of the bar to engage with the electronic lock body, as detailed further herein. Turning the key one direction in the mechanical lock may unlock the mechanical shackle and turning the key the opposing direction may unlock the bar pin to the mechanical lock body. Turning the key to a position between the unlock position of mechanical shackle and the bar pin may lock both the mechanical shackle and the bar pin to the mechanical lock body.

A mechanical lock is coupled with the bar and may be configured to lock and unlock the bar to the mechanical lock body. A bar retainer, such as a bar pin, may be configured to extend through a bar pin aperture and into the mechanical lock body to secure the bar to the mechanical lock body. The bar may have a plurality of bar pin apertures configured along the length of the bar between the extended end and the lock end of the bar. The bar pin apertures may be configured in a row and enable the bar to be coupled by a pin through an appropriate bar pin aperture to enable the bar to rotate up, about the bar pin, and into the bar receiver of the electronic lock. When the distance between the mechanical lock and electronic lock is larger, the bar pin may be configured through a bar pin aperture that is more proximal to the extended end of the bar, and when the distance between the mechanical lock and the electronic lock is closer the bar pin may be configured through a bar pin aperture that is more proximal to the lock end of the bar. The bar may be configured to rotate about the bar pin to enable the bar to rotate up to and engage with the electronic lock to lock the lock end to the electronic lock and then rotate away from the electronic lock when unlocked to allow a gate or door to be opened. Again, this fixed length bar ensures that the bar can't be locked to the electronic lock without the gates being brought together for alignment of the two components, the mechanical lock body and the electronic lock body.

The electronic lock has a bar receiver in the electronic lock body that is configured to receive the bar as it rotates about the mechanical lock bar pin. The bar may be engaged by a latch to retain the bar to the electronic lock and then the bar may be locked by actuating the electronic deadbolt, to lock the bar to the electronic lock body.

The electronic lock system is configured to monitor an identifier of an electronic device that is used to operate the electronic lock and the bar locked thereto. When an electronic device, such as a mobile phone is used to lock or unlock the bar from the electronic lock body, a database may record an identifier of the electronic device, such as a name of the owner, or a phone number or any other electronic address associated with the electronic device. In an exemplary embodiment, a person may have to download an APP on their mobile device and when doing so may be required to provide their name or other suitable identifier so that the system can record this identifier when the mobile device, such as a phone, is used to operate the electronic lock to lock or unlock the bar.

The electronic lock may have a wireless transceiver that is configured to receive a wireless signal from the electronic device. The wireless signal may be a cellular signal, or a short-range wireless signal, such as a Bluetooth signal and the like. A mobile device such as a mobile phone may have to be paired with the lock to operate the lock.

An electronic lock system may be used to track the entry of person's past the electronic lock or through a gate configured with an electronic lock. When a person walks past the electronic lock, the electronic lock may detect their electronic device, or vice versa, wherein the person's electronic device detects the electronic lock and this interface may be recorded by the system in the database. A near field communication device for example may be configured with the electronic lock system and when a mobile phone operating the APP moves within close proximity of about 5 m or less, or even 3 m or 2 m or less, a wireless connection may be made that can be recorded along with the date and time. In this way, an exemplary electronic lock system may be used as a time clock, wherein when the workers enter through the gate in the morning with their electronic device, such as a mobile phone, the time of passing through the gate is recorded along with the person's identifier, such as their name or cell phone number. Then when they leave the worksite, again a connection is made wirelessly by moving through the gate to record when they left the work premises. This method may be used also in an emergency situation to quickly determine who has left the worksite and who may still be in the worksite. If for example, there is a collapse of a structure, or a fire, it would be helpful to emergency responders to know how many people may still be in the building and require evacuation.

A rigid bar, as used herein, is a bar that is self-standing and stiff, wherein the bar will not flex when extended and may be a monolithic part. An exemplary bar is a metal bar or composite bar that has a rectangular cross-sectional shape.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a perspective front view of the electronic lock system configured on a gate with the bar extending from the mechanical lock and the electronic lock to prevent the gate from being opened.

FIG. 2 shows a perspective back view of the electronic lock system configured on a gate in a locked position with the mechanical shackle locked to a first gate and the electronic shackle locked to a second gate.

FIG. 3 shows a perspective back view of the electronic lock system configured on a gate with the bar extending from the mechanical lock and the electronic lock to prevent the gate from being opened.

FIG. 4 shows a perspective back view of the electronic lock system configured on a gate with the electronic shackle and mechanical shackle detached from the electronic lock and mechanical lock, respectively.

FIG. 5 shows a front view of the electronic lock system configured on a gate with the bar extending from the mechanical lock and the electronic lock to prevent the gate from being opened.

FIG. 6 shows a perspective front view of the electronic lock system configured on a gate with the bar unlocked and rotated down from the electronic lock about the bar pin.

FIG. 7 shows a perspective front view of the electronic lock system configured on a gate with the bar unlocked and rotated to align with the first gate to enable the gate to be opened.

FIG. 8 shows a perspective front view of the electronic lock system being unlocked by an electronic device, such as a mobile phone via a wireless signal.

FIG. 9 shows a perspective front view of the electronic lock system now unlocked by the electronic device and this unlocking event logged to record the person that unlocked the gate, John Doe, and the time the lock was unlocked.

FIG. 10 shows a top view of the electronic lock system with the bar extending from the mechanical lock to the electronic lock.

FIG. 11 shows a bottom view of the electronic lock system with the bar extending from the mechanical lock to the electronic lock and with key receivers on each of the mechanical and electronic locks.

FIG. 12 shows a perspective view of the electronic lock system with the mechanical shackle and the electronic shackles removed from the respective mechanical lock and electronic lock, and the bar detached from the two locks with the bar pin removed from the mechanical lock.

FIG. 13 shows a perspective back view of the electronic lock system with the mechanical shackle and the electronic shackles inserted into the respective mechanical lock and electronic lock, and the bar extending from the two locks.

FIG. 14 shows a perspective exploded view of the mechanical lock with the deadbolt removed along with the mechanical shackle and bar pin.

FIG. 15 shows an exploded front view of mechanical lock with the mechanical deadbolt shown.

FIG. 16 shows the mechanical deadbolt having the first shackle arm configured in a locked position in the first shackle arm receiver and the second shackle arm configured in a locked position in the second shackle arm receiver and the bar pin configured in the bar pin receiver in an unlocked position.

FIG. 17 shows the mechanical deadbolt having the first shackle arm configured in an unlocked position in the first shackle arm receiver and the second shackle arm configured in an unlocked position in the second shackle arm receiver and the bar pin configured in the bar pin receiver in a locked position, wherein the deadbolt has been actuated from the position shown in FIG. 16.

FIG. 18 shows the mechanical deadbolt having the first shackle arm configured in a locked position in the first shackle arm receiver and the second shackle arm configured in a locked position in the second shackle arm receiver and the bar pin configured in the bar pin receiver in a locked position.

FIG. 19 shows a perspective exploded front view of the electronic lock.

FIG. 20 shows a perspective exploded back view of the electronic lock.

FIG. 21 shows a perspective view of the electronic deadbolt in a locked position with the electronic deadbolt actuated into the deadbolt receiver and the spring loaded shackle latch configured around the first shackle arm locking the electronic shackle to the electronic lock body.

FIG. 22 shows a perspective view of the electronic deadbolt shown in FIG. 21 now actuated out from the deadbolt receiver enabling the bar 50 to rotate out from the electronic lock body but the spring loaded shackle latch still configured around the first shackle arm locking the electronic shackle to the electronic lock body.

FIG. 23 shows a perspective view of the electronic deadbolt shown in FIG. 22 now with the electronic deadbolt actuated further toward the first arm of the electronic shackle to push the shackle latch to release the insert end of the first arm for removal of the electronic shackle from the electronic lock body.

FIG. 24 shows a mobile phone of an electronic lock user, wherein the mobile phone is operating the APP to display the status of the electronic lock and enable the user to transfer responsibility for locking the electronic lock to another person.

FIG. 25 shows a mobile phone of an electronic lock manager, wherein the mobile phone operates the APP to display the status of the electronic and having a Menu button for the selection of other locks to view and/or to manage lock users.

FIG. 26 shows a mobile phone of an electronic lock user showing the status of the lock and the recent lock history.

FIG. 27 shows a mobile phone of an electronic lock manager on a manager access page that enables the lock manager to provide guest access for a particular start date, days of the week and daily start time and daily end times.

FIG. 28 shows a mobile phone operating the system application software (APP), wherein the APP displays the lock status and lock history of the lock including the date and time of lock actuation and the person that actuated the lock.

FIG. 29 shows a mobile phone operating the system application software (APP) and displaying a lock-map and the location of locks of the system, wherein the map may be interfaced with to select one of the locks to see a status and lock history.

FIG. 30 shows a mobile phone operating the system application software (APP) and displaying a menu of lock site locations, wherein a user may interface with a lock site on the lock site menu to view the number of locks and the responsible person for the lock or locks.

FIG. 31 shows a mobile phone operating the system application software (APP) and displaying a lock management menu wherein a lock operational day and time can be set by interfacing with the touch screen of the mobile device.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to be understood that where possible, features and components from one figure may be included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

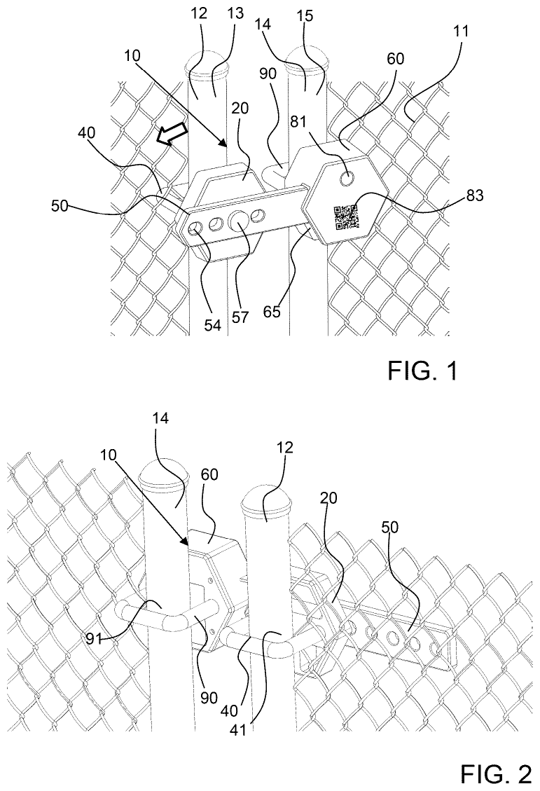

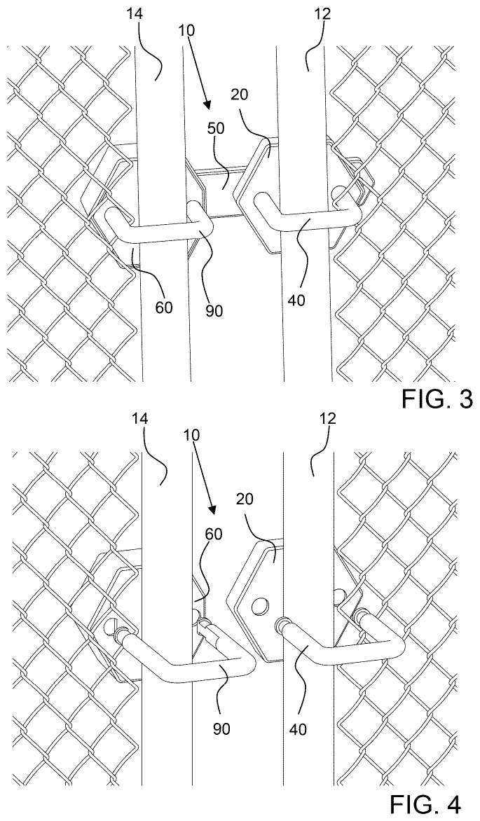

Referring now to FIGS. 1 to 7, an exemplary electronic lock system 10 is configured on gate 11 with the bar 50 extending from the mechanical lock 20 and the electronic lock 60 to prevent the gate from being opened. The mechanical lock 20 is coupled to the first shackle receiver 12, a first gate 13, by the mechanical shackle 40 forming a shackle opening 41 extending around a portion of the first gate. The electronic lock 60 is coupled to the second shackle receive 14, a second gate 15, by the electronic shackle 90 forming a shackle opening 91 extending around a portion of the second gate 15. Bar 50 is retained to the mechanical lock 20 by the bar pin 57 and the bar is configured to rotate about the bar pin. The bar is retained in the electronic lock 60 by the electronic deadbolt (not shown). The bar rotates into bar receiver 65 of the electronic lock body 61. The bar 50 has a plurality of bar pin apertures 54 to enable the bar to be positioned for proper orientation between the mechanical lock 20 and the electronic lock 60. The bar can be secured in a bar pin aperture 54 more proximal to the extended end 56 when the electronic lock is configured further away from the mechanical lock 20.

As shown in FIGS. 1 to 5, the electronic lock system configured in a locked configuration with the bar 50 coupled to the mechanical lock 20 by the bar pin 57 and extending into bar receiver 65 of the electronic lock 60.

As shown in FIG. 4, the electronic lock system is configured on a gate with the electronic shackle 90 and mechanical shackle 40 detached from the electronic lock and mechanical shackle 40, respectively.

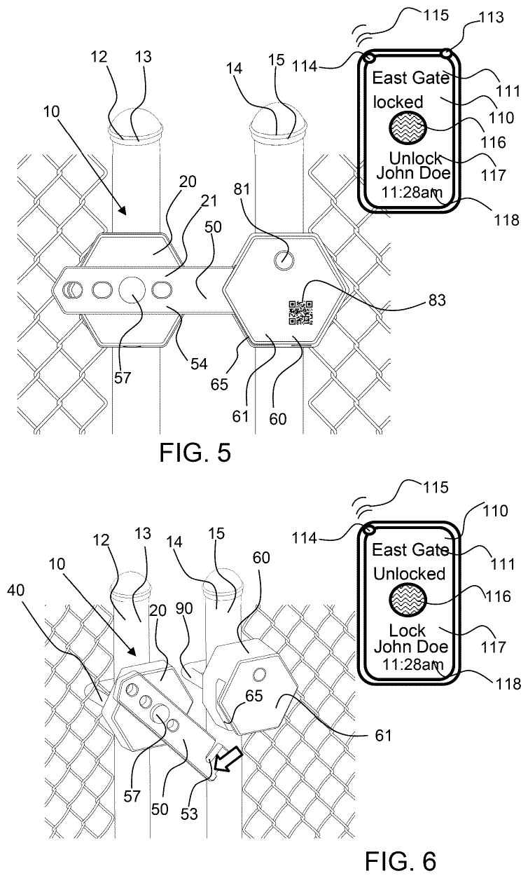

As shown in FIG. 5, an electronic device 110, a mobile phone 111, is being used to unlock the bar 50 from the electronic lock 60 via a wireless signal 115 transmitted by a wireless signal transceiver 114 of the electronic device 110. The mobile phone 111 has a display interface 117 that shows the configuration of the lock, either locked or unlocked, and has a user input 116 to activate the lock to lock or unlock. The interface display also shows a time for the unlocking event, 11:28 am. This time and an identifier 119 of the electronic device, such as the name associated with the electronic device 110, may be recorded by the electronic lock management system. The owner of the electronic device 110 or mobile phone 111, or phone number or electronic address may be recorded as an electronic device identifier. Note that the APP may prompt the user to push the lock button 81 to initiate the actuation of the electronic lock to ensure that a person is in close proximity to the electronic lock when it is actuated.

A Quick Response (QR) code 83 may be configured on the lock system, such as on the mechanical lock body 21 or preferably on the electronic lock body 61 as it has a more exposed front face without the bar 50 extending across the front face. A user may use their electronic device 110, such as a mobile phone 111, to scan the QR code 83 with the camera 113 to synch with the APP. The user may then download the APP and request authorization to activate the lock. A manager of the lock may receive a notice on their mobile phone of a new request and may accept or authorize the new user or deny the request.

As shown in FIG. 6, the bar 50 has been unlocked from the electronic lock 60 via the electronic device 110 and has rotated down out of the bar receiver 65 to disengage from the electronic lock 60. The bar rotates about the bar pin 57. Again, the length of the bar between the mechanical lock 20 and the electronic lock 60 ensures that the second gate 14 has be closed to position the electronic lock 60 for receiving the lock end 52 of the bar 50.

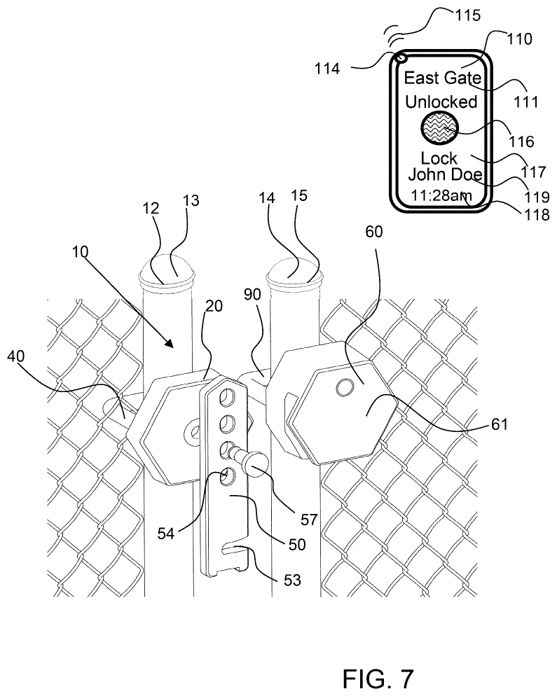

As shown in FIG. 7, the electronic lock system 10 is configured on a gate with the bar 50 unlocked and rotated to align with the first gate 13 to enable the second gate 15 and/or the first gate 13 to be opened.

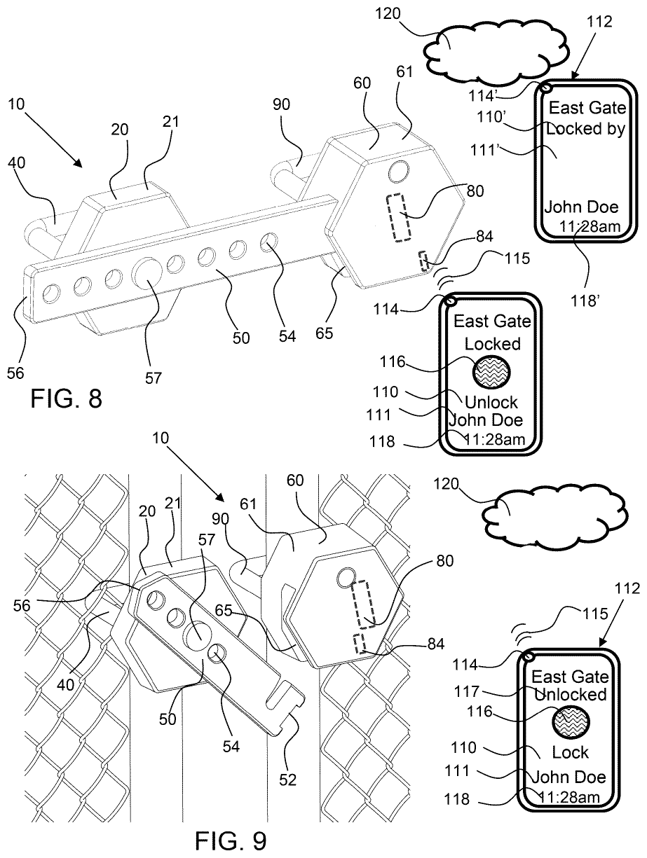

Referring now to FIGS. 8 and 9, the electronic lock management system 112 may utilize a database 120 to record events with one or more locks. This may be helpful on construction sites with multiple locks. As shown in FIG. 7, the owner of electronic device 110 has used the user input 116 to unlock the electronic lock 60 to release the bar 50 from the electronic lock. As shown, a second electronic device 110′, such as a mobile phone 111′ may receive notice through the wireless signal transceiver 114′ that the “East Gate” lock has been unlocked by “John Doe.” This information may be stored on a database 120 to enable a supervisor to see when gates were activated and by whom.

As shown in FIG. 9, the bar is now unlocked from the electronic lock 60 and the electronic device 110 now shows the lock as “unlocked” on the display interface 117. Again, the time 118 that the unlocking event occurred is recorded by the electronic lock management system 112.

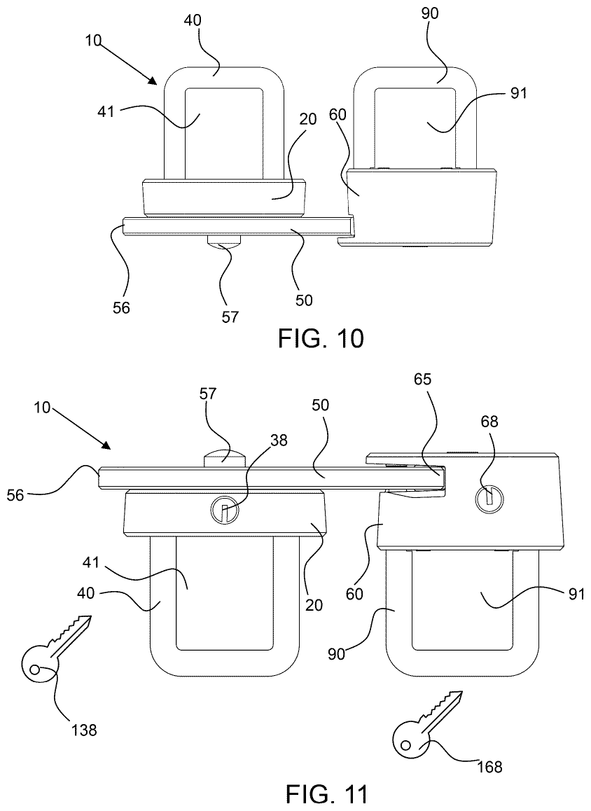

As shown in FIG. 10, the electronic lock system 10 is configured with the bar 50 extending from the mechanical lock 20 to the electronic lock 60.

As shown in FIG. 11, the electronic lock system 10 is configured with the bar 50 extending from the mechanical lock 20 to the electronic lock 60. The key receivers 38 and 68 on each of the mechanical and electronic locks are configured to enable a physical key to lock and/or unlock the respective lock. As described herein, keys 138, 168 may enable the mechanical shackle 40, and electronic shackle 90 to be removed from the mechanical lock 20 and electronic lock 60, respectively. In this way, a physical key may be used to install the electronic lock system to prevent improper use. The key may also unlock the bar and/or unlock the bar pin to enable the bar to be positioned in a proper bar pin aperture to enable the bar to rotate in the bar receiver 65 of the electronic lock 60. Note that a single key may operate both of the mechanical locks and the electronic locks. Also, note that the electronic lock actuator may only function to unlock the bar from the electronic lock. This specific functionality enables a supervisor to install the electronic lock system and then workers to only unlock the bar and not remove the lock components.

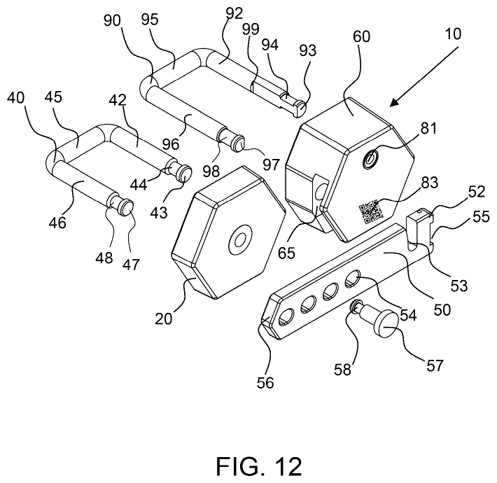

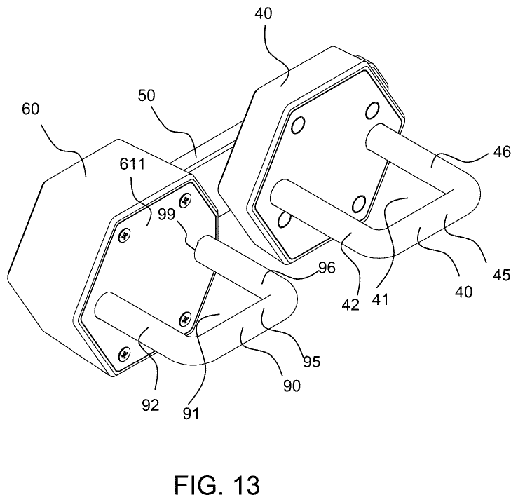

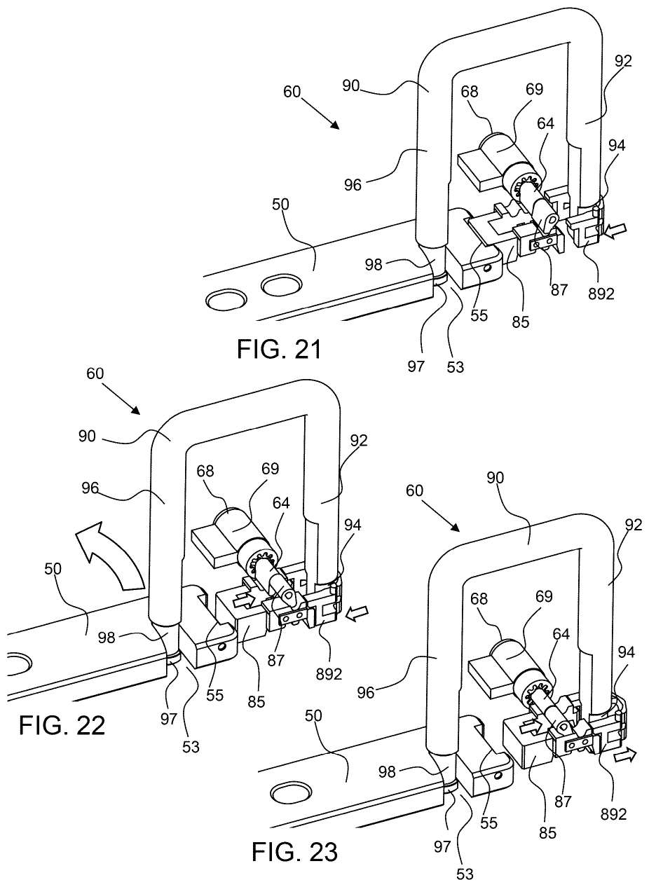

Referring now to FIGS. 12 and 13, the electronic lock system 10 is configured with the mechanical shackle 40 and the electronic shackle 90 removed from the respective mechanical lock 20 and electronic lock 60, and the bar 50 detached from the two locks with the bar pin 57 removed from the mechanical lock 20. The mechanical shackle 40 forms a U-shape with a connector portion 45 extending between a first arm 42 and a second arm 46. The first arm 42 extends from the connector portion to an insert end 43 with a lock receiver 44, a recess forming a flange for interfacing with the deadbolt. The second arm 46 extends from the connector portion to an insert end 47 having a lock receiver 48, forming a flange for interfacing with the deadbolt. Likewise, the electronic shackle 90 forms a U-shape with a connector portion 95 extending between a first arm 92 and a second arm 96. The first arm extends from the connector portion to an insert end 93 with a lock receiver 94, a recess forming a flange for interfacing with the deadbolt. The second arm 96 extends from the connector portion to an insert end 97 having a lock receiver 98, a recess forming a flange for interfacing with the deadbolt. The bar 50 extends from an extended end 56 to a lock end 52 having a shackle receiver 53 proximal thereto. The shackle receiver 53 is a slot that extends into the electronic lock 60 and particularly into the bar receiver 65 and is engaged with the second arm 96 of the electronic shackle 90, as shown in FIG. 21. A lock receiver may be a recess in the bar, such as a recess extending in from an edge of the bar 50. The shackle receiver extends on either side of the lock receiver 98 of the second arm 96 of the electronic shackle 90 when in a locked position, wherein the insert end 97 of the second arm 96 is on one side of the bar to lock the second arm 96 to the bar 50. The bar pin 57 is configured to extend through a bar pin aperture and into the mechanical lock 20.

The first arm and/or second arm of the electronic shackle 90 have a retainer flange 99 that engages with the lock body shackle plate 611 to prevent this plate from being removed or opened by the loosening or removing the retainers. This prevents tampering with the electronic lock 60.

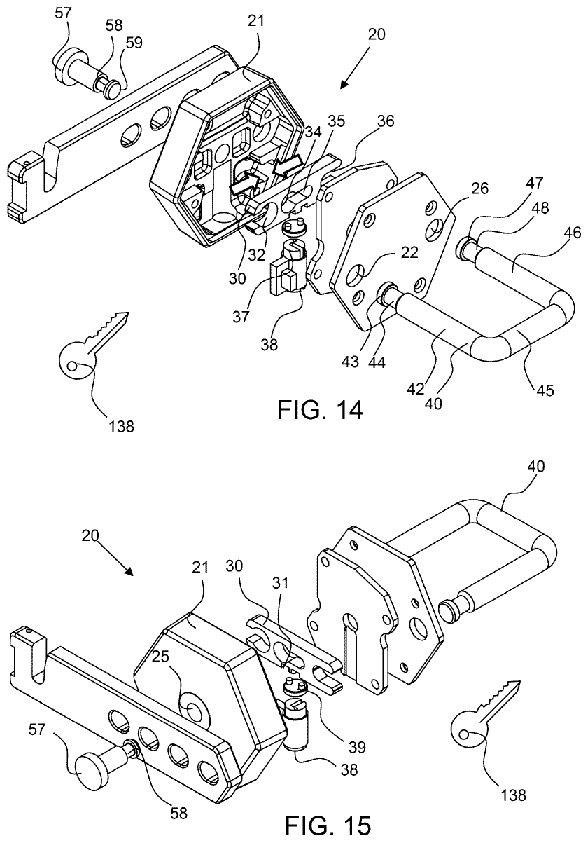

As shown in FIG. 14, the mechanical lock body 21 has shackle receiver 22 and shackle receiver 26, apertures in the lock body for receiving the first arm 42 and second arm 46 of the mechanical shackle 40. As shown, the mechanical shackle can be completely detached from the mechanical lock body 21. This arrangement may be the same for the electronic lock body, wherein the electronic lock body has a pair of shackle receivers for receiving the two arms of the electronic shackle.

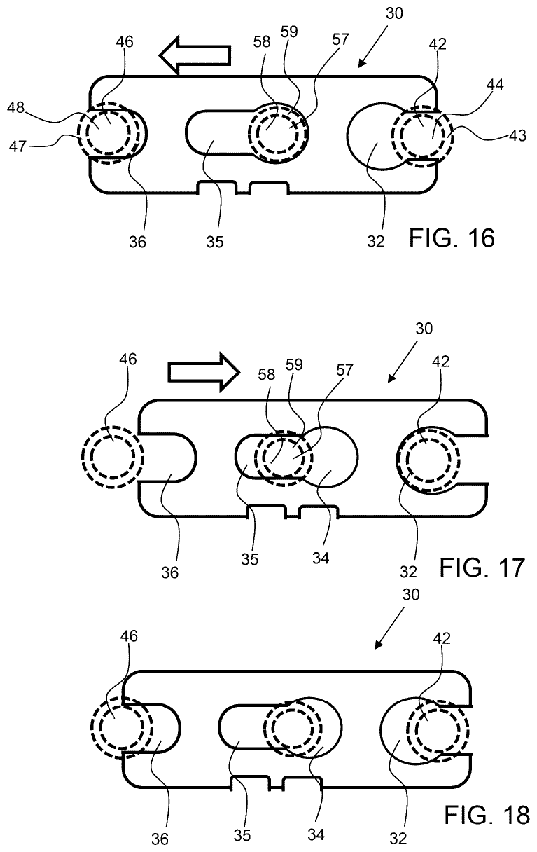

Referring now to FIGS. 14 to 18, the mechanical lock 20 is configured with a deadbolt 30, that is removed to show the various portions of the deadbolt. As shown in FIG. 13, the deadbolt has a first shackle arm receiver 32 configured to receive the insert end 43 of the first arm 42 of the mechanical shackle 40. The lock receiver 44 on the insert end may be configured to align with the first shackle arm receiver 32 of the deadbolt. The lock receiver is smaller in dimension than the insert end 43 and is configured to fit through opening first shackle arm opening 33 on the end of the mechanical deadbolt 30. The mechanical deadbolt has a deadbolt lock interface 31 for interfacing the deadbolt to the key mechanism 39 for that is a deadbolt actuator 37 for actuating the deadbolt by turning the key 138 in the key receiver 38. As shown in FIG. 13, the deadbolt has a second shackle arm receiver 36 configured to receive the lock receiver 48 of the second arm 46 of the mechanical shackle 40. The dimension of the second shackle arm receiver 36 is smaller than the insert end 47 of the second arm 46 of the mechanical shackle 40. The lock receiver 48 on the insert end may be configured to align with the second shackle arm receiver 36 of the deadbolt to enable the deadbolt to actuate to lock and unlock the mechanical shackle. Likewise, the bar pin 57 has an insert end 59 with a bar-pin lock receiver 58 that is configured to align with the bar pin receiver 34. As shown, the bar pin receiver 25 has an enlarged portion to receive the insert end 59 of the bar pin 57, which is larger in dimension than the bar-pin lock receiver 58. The bar pin receiver 34 has a bar pin lock arm that is smaller in dimension than the lock end of the bar pin but is large enough to receive the bar-pin lock receiver 58 of the bar pin 57.

Also shown in FIG. 14 is the key mechanism 39 having a key receiver 38 for receiving the key 138 therein to actuate the deadbolt. The key mechanism 39 interfaces with the deadbolt to actuate the deadbolt back and forth as indicated by the bold arrow above the mechanical deadbolt.

Referring now to 16, the mechanical deadbolt 30 is configured with the first arm 42 configured in a locked position in the first shackle arm receiver 32 and the second shackle arm 46 configured in a locked position in the second shackle arm receiver 36 and the bar pin 57 configured in the bar-pin lock receiver 58 in an unlocked position. The lock receivers 44, 48 of the first arm 42 and second arm 46 are aligned with the deadbolt and the enlarged insert ends 43, 47 prevent the mechanical shackle from being from being removed from the mechanical lock 20.

As shown in FIG. 17, the mechanical deadbolt 30 has been actuated to now unlock the mechanical shackle 40 and lock the bar pin to the deadbolt. The mechanical deadbolt 30 has the insert end 43 of the first arm 42 configured in an unlocked position in the first shackle arm receiver 32 and the insert end 47 of the second arm 46 of the mechanical shackle 40 is configured outside of the second shackle arm receiver 36. Also, the insert end 59 of the bar pin 57 is shown configured in the bar pin receiver 34 of the mechanical deadbolt 30, whereby it now in a locked position.

As shown in FIG. 18, both the mechanical shackle and the bar pin 57 are locked by the deadbolt.

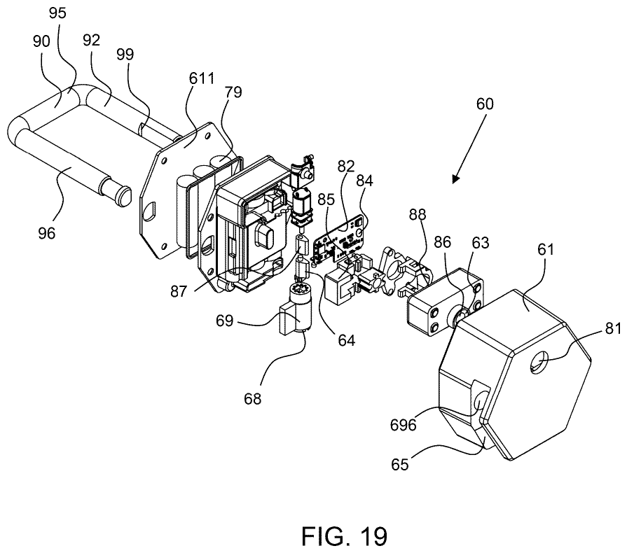

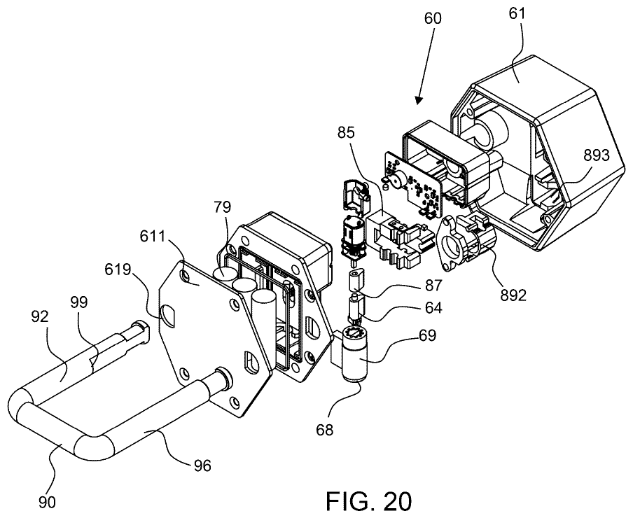

Referring now to FIGS. 19 and 20, the electronic lock 60 is configured with an electronic actuator 87 configured to move the electronic deadbolt 85 to lock and unlock the bar from the electronic lock 60. The electronic lock receives a wireless signal via the wireless signal transceiver 84 and a controller 82 controls the function of the electronic lock actuator to move the electronic deadbolt 85 into the shackle receiver 53 of the bar 50 shown in FIG. 12. One or more sensors may be configured to detect the bar being positioned in the electronic lock body 61. A mechanical sensor 88 that utilizes a spring or other actuating component to detect the bar may be used. A photo sensor 86 may be used to detect the presence of the bar in the bar receiver 65. A spring 893 is compressed when the bar is rotated into the electronic lock body, and this spring may force the shackle latch 892 into position to lock the shackle arm 92 to the electronic lock body. The spring may be coupled with a switch and this switch may relay a signal to the controller. A bar sensor 63, such as a photo sensor 86 may be configured to detect when the bar is configured in a lock position within the electronic lock body 61 and this photo sensor is coupled with the controller 82. The electronic lock 60 also has a key mechanism 69 that is configured to unlock the shackle via insertion of key into the key receiver 68 and turning the key mechanism. The electronic lock 60 has a battery 79 to power the electronic lock, the signal transceiver and other electronic components.

FIG. 20 shows a perspective exploded back view of the electronic lock 60. The electronic shackle 90 has the retainer flange 99 that locks the lock-body shackle plate 611 in position when the electronic shackle is locked to the electronic lock body 61. The batteries 79 are shown that power the electronic actuator as well as the controller and the electronic lock wireless signal transceiver. The key mechanism 69 actuates the key actuator 64 to move the electronic deadbolt 85. The electronic actuator 87 also engages with the electronic deadbolt 85 to unlock the bar from the electronic lock body 61, but not the electronic shackle 90.

Referring now to FIGS. 21 to 23, the electronic lock 60 has an electronic deadbolt 85 that is actuated by the electronic actuator 87 and also by the key actuator 64. The electronic actuator is configured to actuate the electronic deadbolt to move out from the deadbolt receiver 55 of the bar 50 to allow the bar to rotate out and away from the electronic deadbolt body to open a gate. As shown in FIG. 21, the electronic deadbolt 85 is inserted into or engaged with the deadbolt receiver 55 of the bar 50. Also, in FIG. 21, the shackle latch 892, which may be a spring loaded shackle latch 892, is forced into a locked position by a spring 893 (shown in FIG. 20). The shackle latch 892 extends into the lock receiver 94 to lock the insert end of the first arm 92 in position.

As shown in FIG. 22, the electronic deadbolt is actuated to move out of the deadbolt receiver 55 and release the bar, wherein the bar 50 can then rotate away, as indicated by the curved bold arrow, from the electronic lock 60. Note that the lock receiver 98 is retained in the shackle receiver 53 with the insert end 97 extending past the bar. The insert end 97 forms a shackle flange on the insert end that is retained by the edges of the shackle receiver slot. In this configuration, the shackle latch 892 is still engaged with the lock receiver 94 of the first arm 92 to lock the first arm 92 to the electronic lock 60. Also, the electronic actuator 87 has actuated the electronic deadbolt 85.

As shown in FIG. 23, the electronic deadbolt 85 is actuated further toward the first arm 92 of the electronic shackle 90 to push the shackle latch 892 to release the insert end of the first arm 92 for removal of the electronic shackle 90 from the electronic lock body. The key actuator 64 may be required for movement of the electronic deadbolt to this position, whereby only a manual key actuation enables removal of the electronic shackle. The key or keys therefore may be used for installation of the lock system onto a gate and then the electronic actuator 87 may be used to lock and unlock the bar from the electronic lock body.

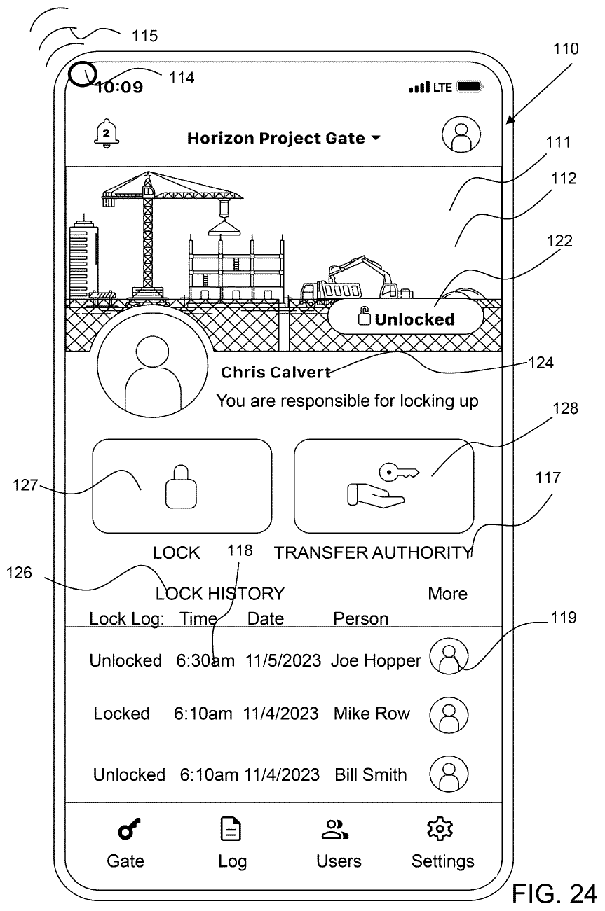

As shown in FIG. 24, a mobile phone 111 of an electronic lock user is operating the APP of the electronic lock management system 112 to display the lock status 122 of the electronic lock including the lock actuation time 118 and the identifier 119 of the person last actuating the lock. In addition, the lock interface has a lock actuator interface 127, to lock the now unlocked electronic lock. Also, the display interface 117 shows the responsible person identifier 124 and has a transfer responsibility interface 128 for transferring locking responsibilities of the electronic lock to another person. At the bottom of the display interface is the lock history 126.

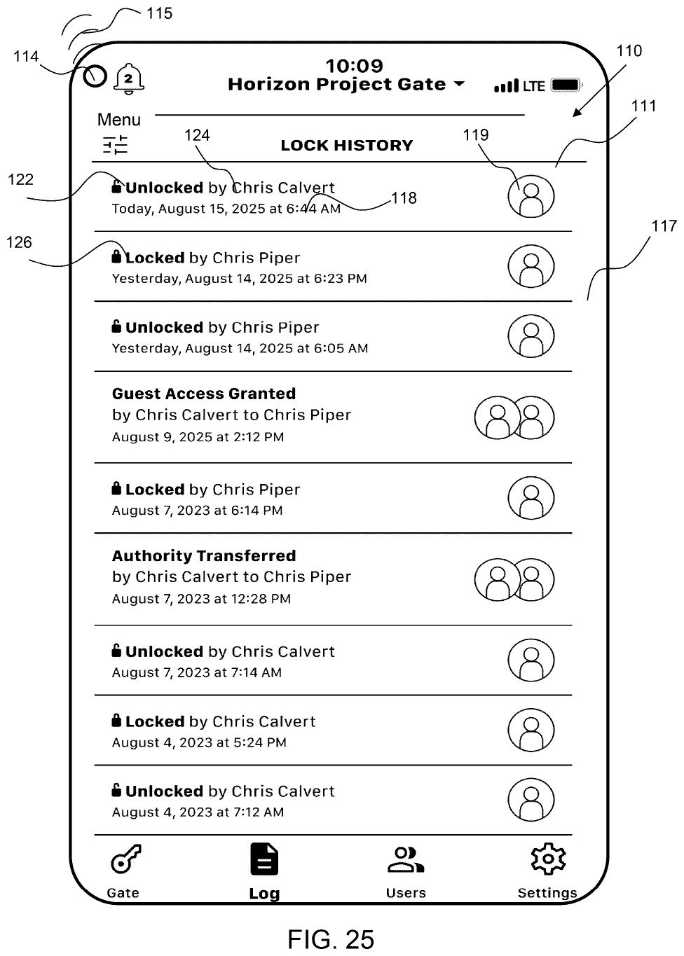

As shown in FIG. 25, a mobile phone 111 of an electronic lock user is displaying the lock history 126 including the lock actuation, time of actuation, date of actuation, and identifier of the person actuating the lock is provided. At the top of the display interface 117 is a menu button that a manager can use to add or remove authorized users and manage the date ranges, time, and days of authorization for a particular electronic lock.

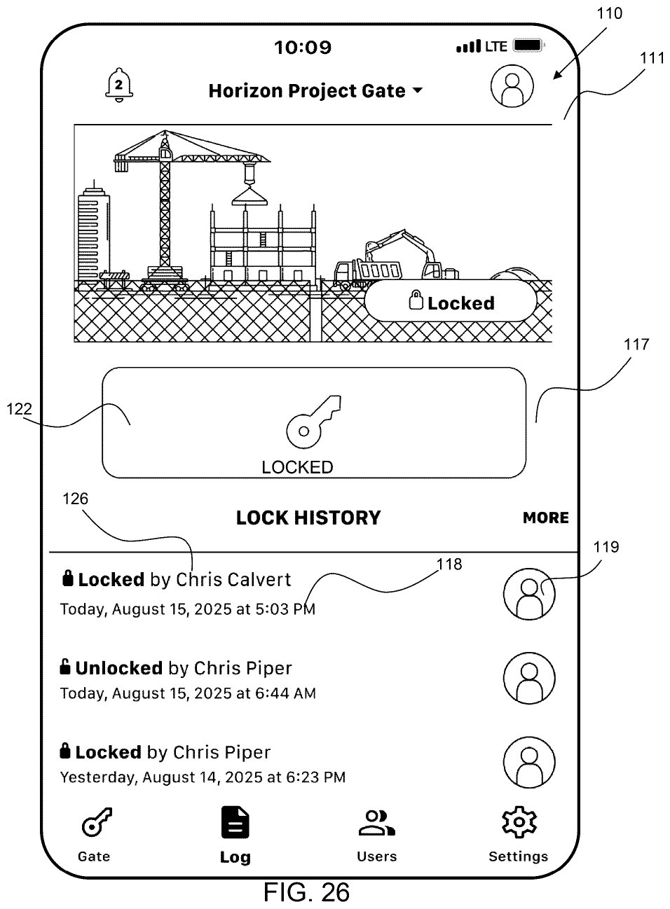

FIG. 26 shows a mobile phone of an electronic lock user showing the lock status 122 of the lock and the recent lock history 126. The display interface 117, such as a touchscreen, may be used to select views of different gates to view the status of other gates.

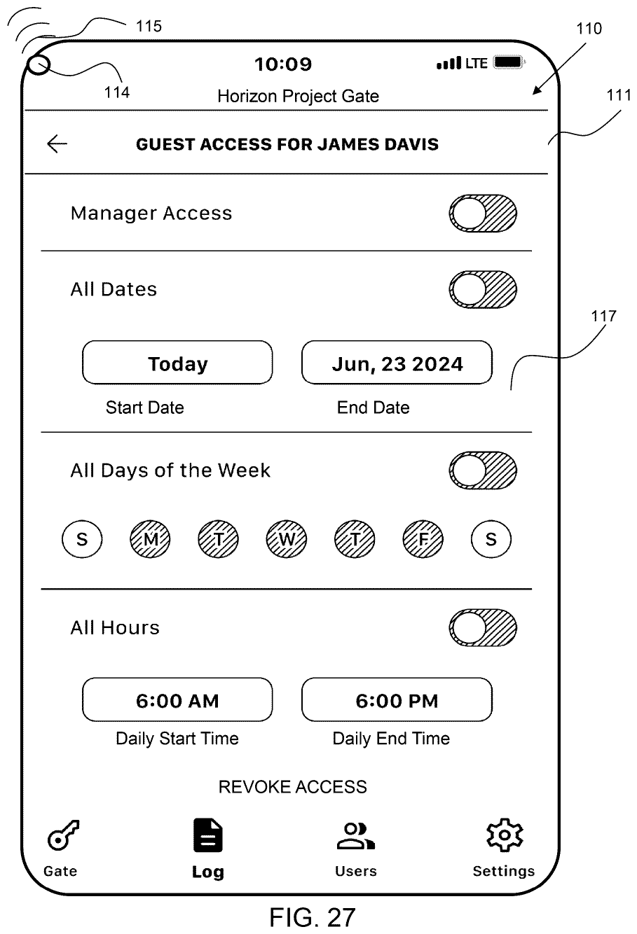

FIG. 27 shows a mobile phone 11 of an electronic lock manager on a manager access page that enables the lock manager to provide guest access for a particular start date, days of the week and daily start time and daily end times.

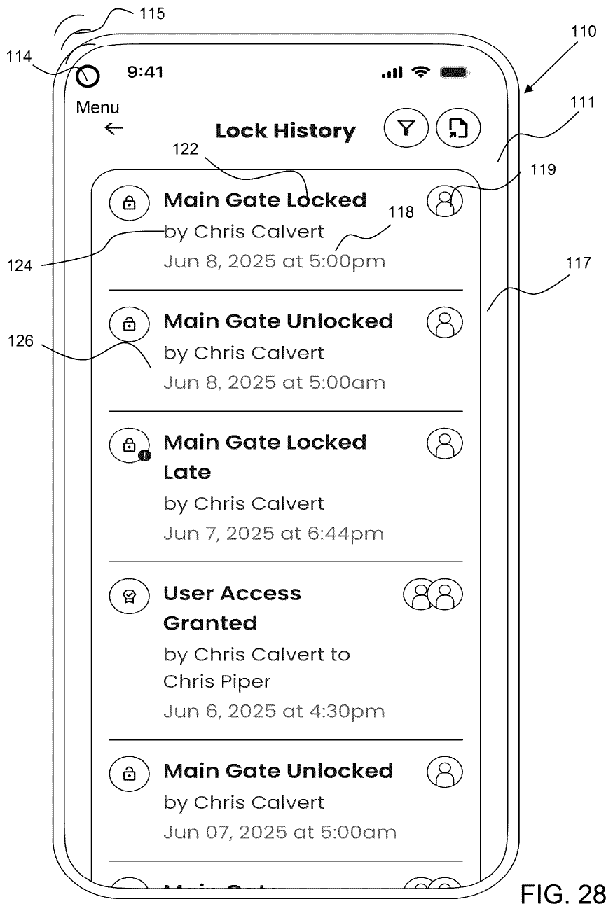

FIG. 28 shows a mobile phone 111 operating the system application software (APP), wherein the APP displays the lock status 122 and lock history of the lock including the date and time of lock actuation and the responsible person 124 that actuated the lock.

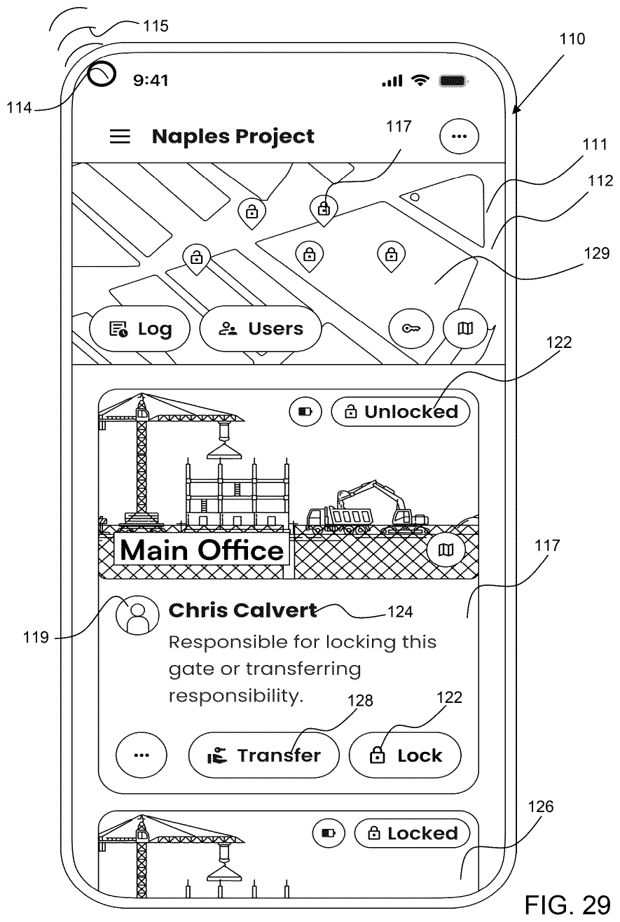

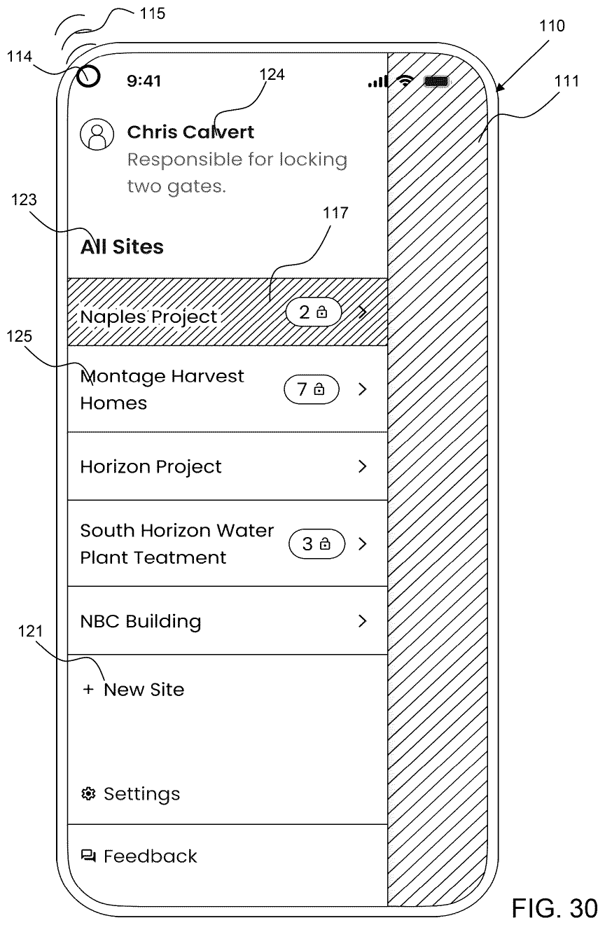

FIG. 29 shows a mobile phone 111 operating the system application software (APP) and displaying a lock-map 129 and the location of locks of the system, wherein the map may be interfaced with through the user interface 117 to select one of the locks to see a lock status 122 and lock history 126.

FIG. 30 shows a mobile phone 111 operating the system application software (APP) and displaying a menu of lock site locations, wherein a user may use the user interface 117 to choose a lock site icon 125 on the lock site menu 123 to view the number of locks and the responsible person 124 for the lock or locks for that lock site. Also, a new site may be input to the system through selecting the new site icon 121.

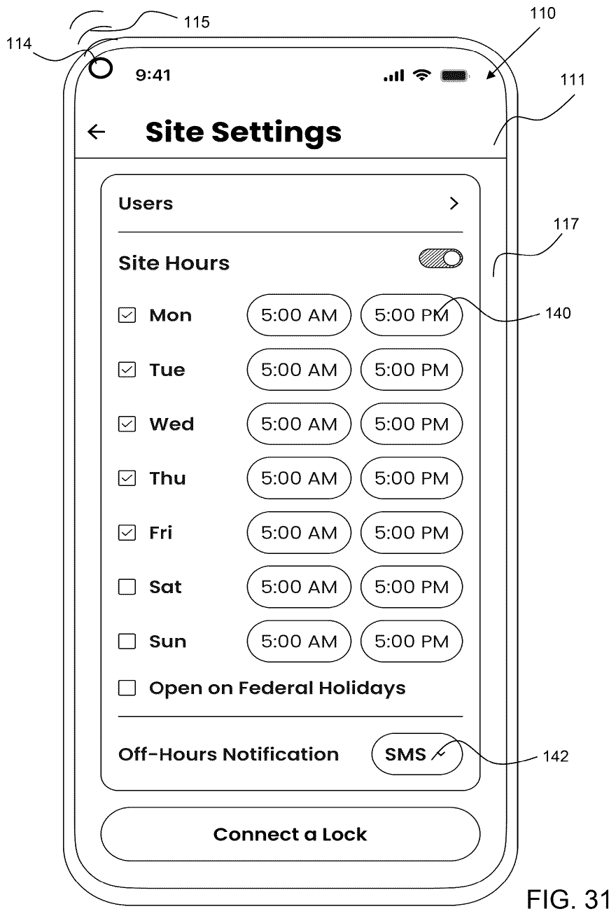

FIG. 31 shows a mobile phone 111 operating the system application software (APP) and displaying a lock management menu 144 having a lock operation setting 140 wherein a lock operational day and time can be set by interfacing with the touch screen of the mobile device. Also an off-operation notice 142 may be used to set one or more contacts to be notified when a lock is actuated off-hours. This lock window time may prevent unauthorized access to a work site during off hours to prevent theft or injury on the work site. When the lock is actuated outside of these set operational times, a notice such as an SMS text, or text message, of a call or alarm may be initiated on one or more devices, such as a managers mobile phone, and or may be sent to a security guard and/or the authorities, such as the police.

It will be apparent to those skilled in the art that various modifications, combinations, and variations can be made in the present invention without departing from the scope of the invention. Specific embodiments, features and elements described herein may be modified, and/or combined in any suitable manner. Thus, it is intended that the present invention covers the modifications, combinations and variations of this invention provided they come within the scope of the appended claims and their equivalents.

What is claimed is:

1. A method of managing a lock comprising:
a) providing an electronic lock system comprising:
i) a mechanical lock comprising:
a mechanical lock body;
a mechanical shackle that is configured to lock to and unlock to the mechanical lock body;
a mechanical deadbolt; and
a key mechanism having a key receiver;
wherein the key mechanism is configured to actuate the mechanical deadbolt to lock and unlock the mechanical shackle;
ii) an electronic lock comprising:
an electronic lock body;
an electronic shackle that is configured to lock and unlock to the electronic lock body;
an electronic deadbolt;
a controller;
a wireless signal transceiver coupled with the controller;
a bar sensor;
an electronic lock actuator configured to actuate the electronic deadbolt; and
a key mechanism having a key receiver;
wherein the key mechanism is configured to actuate the electronic deadbolt to lock and unlock the electronic shackle;
iii) a bar configured to couple to the mechanical lock and extend to the electronic lock and wherein the electronic deadbolt is configured to lock the bar to the electronic lock body;
wherein the bar sensor is configured to detect when the bar is locked to the electronic lock body;
iv) a key;
v) an electronic device configured to provide instruction via a wireless signal to the wireless signal transceiver of the electronic lock to actuate the electronic deadbolt; and
vi) a database configured to communicate with the electronic lock and store a status of the electronic lock position and lock events of the electronic lock including an identifier of said electronic device corresponding to a lock event;
b) locking the mechanical shackle of the mechanical lock to a first shackle retainer with said key;
c) locking the electronic shackle of the electronic lock to a second shackle retainer with said key;
d) securing the bar between the mechanical lock body and the electronic lock body and locking the bar to the electronic lock;
e) unlocking the bar from the electronic lock body using said electronic device to send a wireless signal to the electronic lock; and
f) recording an identifier of the electronic device on said database.

2. The method of claim 1, wherein the bar is a rigid bar that is a monolithic component.

3. The method of claim 1, wherein the electronic actuator only actuates the electronic deadbolt to unlock the bar from the electronic lock body.

4. The method of claim 1, wherein the electronic lock system further comprises a bar pin and wherein the bar is coupled to the mechanical lock body by said bar pin.

5. The method of claim 4, wherein the bar is configured to rotate about the bar pin.

6. The method of claim 5, wherein the bar has a plurality of bar pin apertures configured to receive said bar pin therethrough.

7. The method of claim 5, wherein the bar pin has a bar pin lock receiver that is configured to engage with the mechanical deadbolt to lock the bar pin to the mechanical lock body.

8. The method of claim 7, wherein the key is configured to actuate the mechanical deadbolt to lock and unlock the bar pin to the mechanical lock body.

9. The method of claim 1, wherein the bar has a bar lock receiver that is configured to engage with the electronic deadbolt to lock the bar to the electronic lock body.

10. The method of claim 1, wherein the mechanical shackle comprises:
a) a first arm that extends to an insert end and has a lock receiver; and
b) a second arm that extends to an insert end and has a lock receiver; and
wherein the electronic lock further comprises a shackle latch configured to lock the first arm of the electronic shackle to the electronic lock; and
wherein the key mechanism of the mechanical lock is configured to move the electronic deadbolt to actuate the shackle latch and unlock the first arm of the electronic shackle to the electronic lock.

11. The method of claim 10, wherein the electronic actuator only actuates the electronic deadbolt to unlock the bar from the electronic lock body.

12. The method of claim 10, wherein each of the first arm and second arm are locked by the mechanical deadbolt.

13. The method of claim 1, wherein the electronic shackle comprises:
a) a first arm extending to an insert end and having a lock receiver; and
b) a second arm extending to an insert end and having a lock receiver.

14. The method of claim 13, wherein the electronic lock further comprises a shackle latch configured to lock the first arm of the electronic shackle to the electronic lock.

15. The method of claim 14, wherein the key mechanism of the electronic lock is configured to move the electronic deadbolt to actuate the shackle latch and unlock the first arm of the electronic shackle to the electronic lock.

16. The method of claim 15, wherein the electronic actuator only actuates the electronic deadbolt to unlock the bar from the electronic lock body.

17. The method of claim 1, wherein both the mechanical shackle and the electronic shackle are detachable attachable to the respective mechanical lock body and the electronic lock body.

18. The method of claim 1, wherein the electronic device is a mobile phone that operates an APP to interface with the electronic lock, and wherein the mobile phone has a display interface including a user input to actuate the electronic lock to lock or unlock of the bar from the electronic lock body.

19. The method of claim 18, wherein an identifier of said electronic device that was used to actuate the lock is recorded on the database.

20. The method of claim 18, wherein a lock history is displayed on the electronic device, wherein the lock history includes a date and time of lock actuation and an identifier of the electronic device that actuated the electronic lock.

21. The method of claim 20, wherein the lock history further includes a lock actuation position.

22. The method of claim 20, wherein a plurality of electronic devices are configured to interface with the database to determine a lock configuration of the electronic lock.

23. The method of claim 18, wherein the mobile phone has a display interface including a current lock configuration of locked or unlocked.

24. The method of claim 23, wherein the display interface includes an identifier for a responsible person to lock the electronic lock.

25. The method of claim 24, wherein the display interface of the mobile phone includes a transfer responsibility interface that is configured to enable a first person to transfer lock responsibility to a second person through the APP.

26. The method of claim 18, wherein the APP has a manager function to enable a manager to provide authorization for a person to actuate the electronic lock.

27. The method of claim 26, wherein the manager function enables the manager to provide authorization for said person to actuate the electronic lock over a timeframe.
